(19) United States
(12) Patent Application Publication
(10) Pub. No.: US 2013/0113215 A1
(43) Pub. Date: May 9, 2013

(54) FLUID ACTUATED ENERGY GENERATOR

(71) Applicant: Steven Corcoran, Cawood (GB)

(72) Inventor: Steven Corcoran, Cawood (GB)

(21) Appl. No.: 13/641,274

(22) PCT Filed: Apr. 13, 2011
(86) PCT No.: PCT/GB11/00576

§ 371 Date: Jan. 23, 2013

(30) Foreign Application Priority Data
Apr. 13, 2010 (GB) 1006155.4
Apr. 26, 2010 (GB) 1006870.8

(51) Int. Cl. F03B 13/00

(52) U.S. Cl. CPC F03B 13/00
USPC 290/54

(57) ABSTRACT

A fluid actuated energy generator comprises; an output shaft (44) rotatably mounted in a housing (54), a first linkage (36) arranged to rotate with the output shaft (44) and extending in an axis orthogonal to the axis of the output shaft (44), a second linkage (22) rotatably mounted in relation to the first linkage at the radially most distal end thereof, the first and second linkages (36, 22) arranged for rotation in parallel planes, an actuating arm (4) rotatably mounted in relation to the second linkage (22) at the radially most distal end thereof and arranged for rotation in a parallel plane with the first and second linkages (36,22) and at least one blade (2) rotatably mounted in relation to the arm (4) at the radially most distal end thereof and arranged for rotation in a parallel plane with the arm (4), first and second linkages (36, 22), the longitudinal axis of the blade (2) extending orthogonally to the longitudinal axis of the arm (4).

The present invention relates to renewable energy apparatus and in particular to devices which convert energy from natural sources such as wind, wave and tidal changes into a form which can be used to generate electrical power for domestic and industrial use.

### BACKGROUND TO THE INVENTION

Many devices have been invented for the production of electricity from natural means such as wind, wave and tidal. However the majority of these devices suffer from the same common problems. The first common problem they suffer is cost, typically existing units are very expensive not only to manufacture but also to install and uninstall. The second common problem is one of the ability of devices to work across a potentially large range of input fluid velocity which is typical incurred in most applications. The third common problem is scalability where the majority of devices are not able to be cost effectively utilised at a medium or small scale. A fourth common issue is fluctuations in the source energy which can lead to local area flicker caused by starts and changing conditions of the source. A device which is able to overcome these common issues will have a distinct advantage over the prior art devices.

In particular to sub surface types of devices further common issues are apparent such as the changing environmental conditions and the usage of hydraulics. The changing environment conditions (the fifth issue) is present in many areas such as rivers and estuaries. Typically the amount of water and therefore the depth of the water in any area will fluctuate respective to elements such as the weather and the tide. Currently sub surface devices are fixed and as such cannot change to accommodate fluctuating water depths. The devices require a depth of water in which to operate and this prohibits many suitable locations being used for renewable energy generations.

The sixth issue is the use of hydraulics and this has many considerations. The first such consideration is the amount of force required by the device to operate a hydraulic system to not only to overcome the force required to simply cause the hydraulic system to operate but also to overcome the massive losses which are present in hydraulic systems. The second such consideration is the limited nature in terms of the viscosity of the oil such that the overall speed at which a device can operate is low and typically not changeable. The third consideration is the large weight and size of any hydraulics assembly which adds complexity to all aspects of the product including its manufacture, shipment to location and maintenance. Finally but not limited to is the environmental issues surrounding oil whereby the prior art hydraulic systems require a significant amount of oil and thus there are environmental concerns whereby if a leak occurred, not only would the device reduce its output capacity and eventually stop working, their would also be considerable environmental contamination.

The present invention seeks to overcome some or all of the aforementioned problems of the prior art with a design which is flexible, changeable and able to be produced at very little cost.

### STATEMENT OF THE INVENTION

In accordance with the present invention there is provided a fluid actuated energy generator comprising; an output shaft rotatably mounted in a housing, a first linkage arranged to rotate with the output shaft and extending in an axis orthogonal to the axis of the output shaft, a second linkage rotatably mounted in relation to the first linkage at the radially most distal end thereof, the first and second linkages arranged for rotation in parallel planes, an actuating arm rotatably mounted in relation to the second linkage at the radially most distal end thereof and arranged for rotation in a parallel plane with the first and second linkages, and at least one blade rotatably mounted in relation to the arm at the radially most distal end thereof and arranged for rotation in a parallel plane with the arm, first and second linkages, the longitudinal axis of the blade extending orthogonally to the longitudinal axis of the arm.

In some embodiments, the generator further includes a third linkage rotatably mounted between the first linkage and the second linkage at the radially most distal end of the first linkage and the radially most proximal end of the second linkage.

The first linkage may be connected directly or indirectly to the output shaft, optionally the first linkage is connected to a first of a chain of gears, the last gear in the chain being directly connected to and configured to rotate the output shaft. The first linkage may be connected to the first gear in the chain eccentrically or centrally. Where just two linkages are present, it is advantageous to attach the first linkage to the first of the gears eccentrically whereby a rotation of the gear causes the attachment point of the first linkage to scribe a circle.

The blade is conveniently formed as a cambered foil such as a hydrofoil or aerofoil.

Any of the linkages and any section of the arm may incorporate a linear actuator for adjusting the axial length of the linkage or arm section.

Optionally, one or more multi-axis joints are incorporated at the proximal and/or distal ends of one or more of the first, second and third linkages The multi-axis joint may form the rotatable mount and may, for example, comprise a Rose joint.

Any of the rotatable mounts may comprise a powered rotary actuator.

The output shaft can, optionally be connected as an entry shaft to one or more gear boxes. Multiple gear boxes may be arranged in a chain with the exit shaft of one gear box forming the entry shaft of an adjacent one in the chain For example, the gear boxes is a planetary epicyclical type gear box arranged to transform a low rotational entry shaft speed into a relatively higher rotational exit shaft speed.

The blade may be mounted to facilitate rotation about an axis which extends through its body.

The actuating arm optionally includes multiple rotatable joints. Optionally the arm includes one or more multi-axis joints such as, for example, a rose joint.

The generator optionally incorporates one or more resilient, energy storing means arranged in relation to one or more of the linkages and/or arm sections to absorb energy when movement of the linkage or arm section occurs in a first direction and release energy when the linkage or arm section moves in a second direction. Such energy storing means may, for example be responsive to linear movement of a linkage or arm section, if a linear actuator is present, responsive to length adjustments resulting from actions of the linear actuator. The resilient energy storing means, for example comprises one or more of a spring, cam gear or cam arm. Where a spring is used it may be configured to store and release energy through rotational motion or through linear motion.

Any of the rotatable mounts may comprise a rotary actuator. Multiple rotary actuators may be arranged to rotate independently of others at a different speed and/or direction, or may be arranged to rotate in synchronicity with each other.

Multiple linear actuators associated with two or more linkages, may be arranged to adjust length of a linkage independently of other(s) at a different speed and/or in a different direction. Two or more linear actuators may be arranged to adjust length of a linkage in synchronicity with each other.

A single actuating arm may be arranged to operate with two sets of linkages and output shaft.

A second actuating arm may be rotatably mounted on the same axis as the first actuating arm and optionally the second actuating arm may extend in an opposite direction or the same direction as the first actuating arm.

A clutch system may be associated with the output shaft and configured selectively to connect and disconnect the shaft with a generator.

One or more rotary actuator may be in the form of a gearbox comprising: an actuator; a leadscrew arranged to be rotated about its axis by the actuator; a rack nut threadingly engaged with the leadscrew, and arranged such that rotation of the leadscrew drives the rack nut longitudinally with respect to the leadscrew; a toothed section integral with or coupled to the rack nut for longitudinal movement with the rack nut; a shaft; a gear integral with or coupled to the shaft, and arranged such that rotation of the gear causes rotation of the shaft and the toothed section arranged to mesh with the gear such that the longitudinal movement of the toothed section causes rotation of the gear and wherein the toothed section is radially distanced from the leadscrew permitting housing of the leadscrew in a chamber separate from the toothed section. Such a gearbox optionally includes an energy storage means arranged to store energy during at least part of the rotation of the shaft to be released during another part of the rotation of the shaft and in which the energy storage means comprises a spring associated with the gear.

One or more linear actuators may comprise a leadscrew rotatably mounted about its longitudinal axis and including a threaded portion; a drive rod including a threaded portion threadingly engaged with the threaded portion of the leadscrew, the drive rod having an axis generally coincident with or parallel to the longitudinal axis of the leadscrew, and mounted to permit longitudinal movement along its axis and to allow relative rotation between the leadscrew and the drive rod; a sheath provided around the drive rod; and, a gear column arranged generally coaxially with the axis of the leadscrew and encircling the leadscrew, rod and sheath, the gear column including a gear through which drive can be applied to rotate the gear column, and being fixedly attached to the leadscrew such that rotation of the gear column causes rotation of the leadscrew with respect to the drive rod to cause the drive rod to extend and/or retract. The linear actuator may optionally include an energy storage means arranged to store energy during at least part of the length adjustment cycle, the energy storage means being in the form of a spring arranged around and/or otherwise engaging with the piston.

The arm or any linkage may include one or more second axis rotary actuators arranged to provide rotation in a plane orthogonal to the rotatable mounts thereby to enable roll pitch and yaw movements of the leading edge of the blade.

In one particular embodiment a first gear wheel is arranged for rotation with the output shaft, the gear wheel engaging, either directly or via a gear chain with a toothed ring and the toothed ring also engaging with one or more additional gear wheels separate from the first gear wheel, the additional gear wheels each mounted for rotation with a second output shaft. Optionally the second output shaft has a clutch system associated therewith and the clutch system is configured selectively to connect and disconnect the shaft with a generator. In particular when there are just two linkages present, it is advantageous to attach the first linkage eccentrically of the gear wheel whereby a rotation of the gear wheel causes the attachment point of the first linkage to scribe a circle.

Optionally the generator further includes one or more floats tethered to one or more of the one or more actuating arms. The floats optionally feature solar panels arranged to charge batteries carried in the floats or another part of the generator and optionally in addition power points from which power can be drawn by an external device.

Generators in accordance with the invention are preferably arranged for operation beneath a body of water, for example an ocean, stream or any body of water where there is natural disturbance of the water.

The output shafts of the generator are arranged, in use, to serve as an input shaft to drive a generator from which electrical power can be generated.

A controller, for example a pre programmed computer processor may be incorporated for selectively controlling the operation of moving parts whereby to optimise the output of the devices of the invention.

The devices of the invention are expected to be used as a sub surface application such as under the surface of the sea or a river or estuary. A sub surface device is typically installed in tidal or any flow condition. Tidal conditions and their locations is self explanatory, however flow conditions can cover a wide variety of locations such as but not limited to rivers where water feeds into the river from mountainous or other differential gradient regions or under sea currents and flow between land masses (such as but not limited to through channels between islands). It will be appreciated tidal sources of flow can be additional to any flow condition.

The current invention overcomes issues detailed above with a simple adjustable mechanism structure which is able to change its geometry both internally and externally such that it is, for example, able to adjust respective to flow as well as change characteristics respective to other devices of this or other types in the direct or indirect area. This ability to vary its geometry allows not only a greater range of operation but also the ability to adapt itself with respect to turbulence or other fluid effects resultant from use as well as its operational parameters.

In the case of the present invention, it is known that the device produces a pattern in the flow of the fluid post to its operation. This pattern is able to be used to effect change in an area respective to the device, its operation and fluid flow direction. The ability to form a pattern in the fluid allows for the device, whether or not generating electricity, to use the pattern to, for example but without limitation, move sediment from one location to another. It will be appreciated that this ability to relocate and disperse sediment can occur with multiple or singular devices.

### DESCRIPTION OF SOME EMBODIMENTS

Some embodiments of the invention are now described with reference to the accompanying Figures in which:

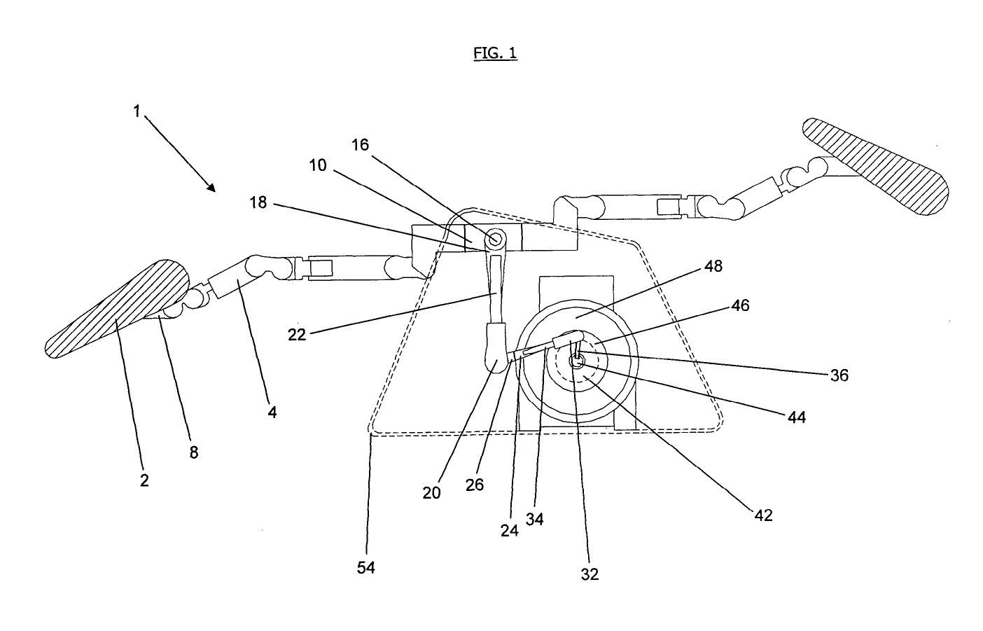

FIG. 1; a side view of a first embodiment of the invention

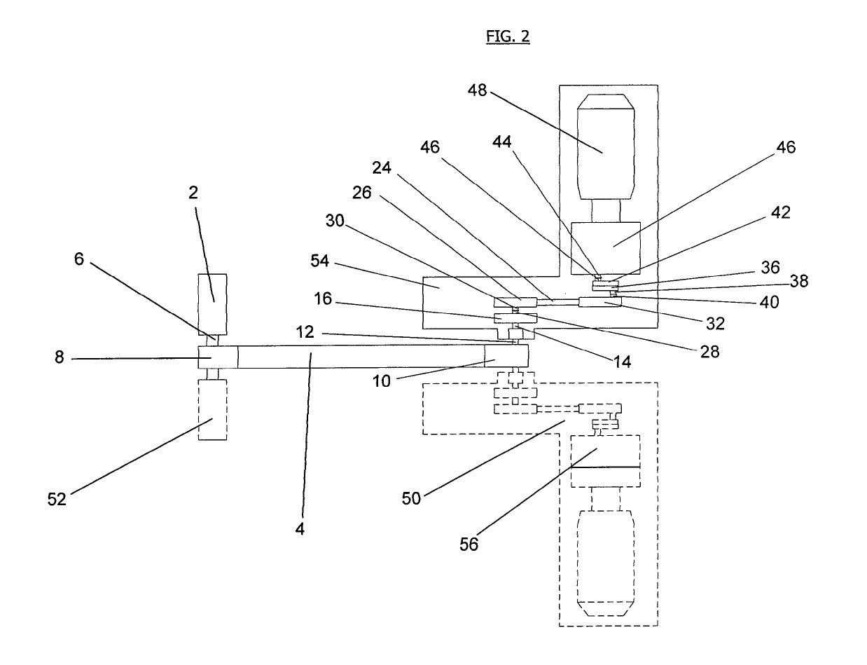

FIG. 2; a plan view showing a second embodiment of the invention which is substantially the same as the first embodiment but illustrates how a second generator and blade might be incorporated into the embodiment of FIG. 1.

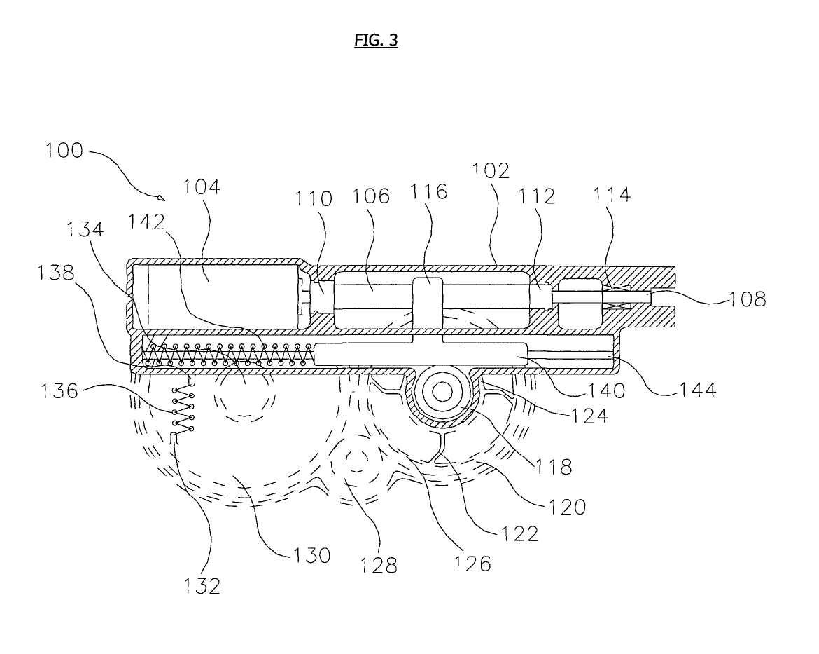

FIG. 3; a side view of a gearbox able to be used in any embodiment

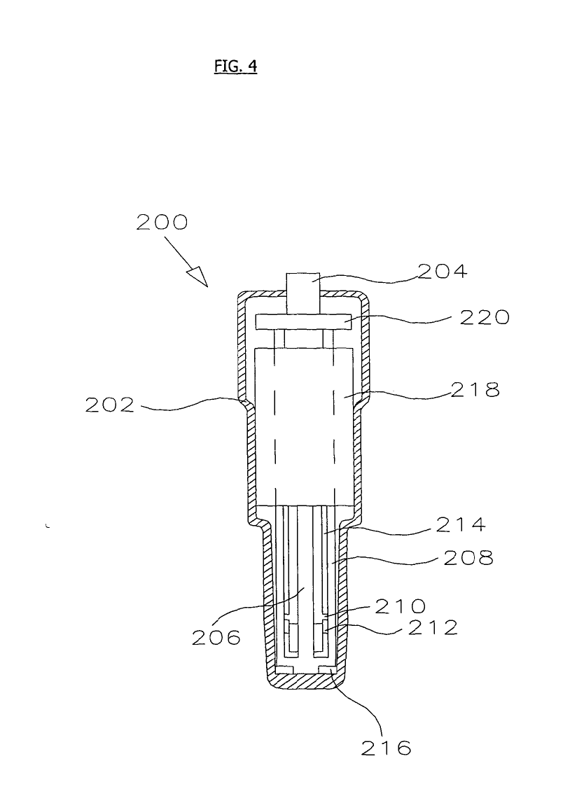

FIG. 4; a side and section view of a linear actuator able to be used in any embodiment

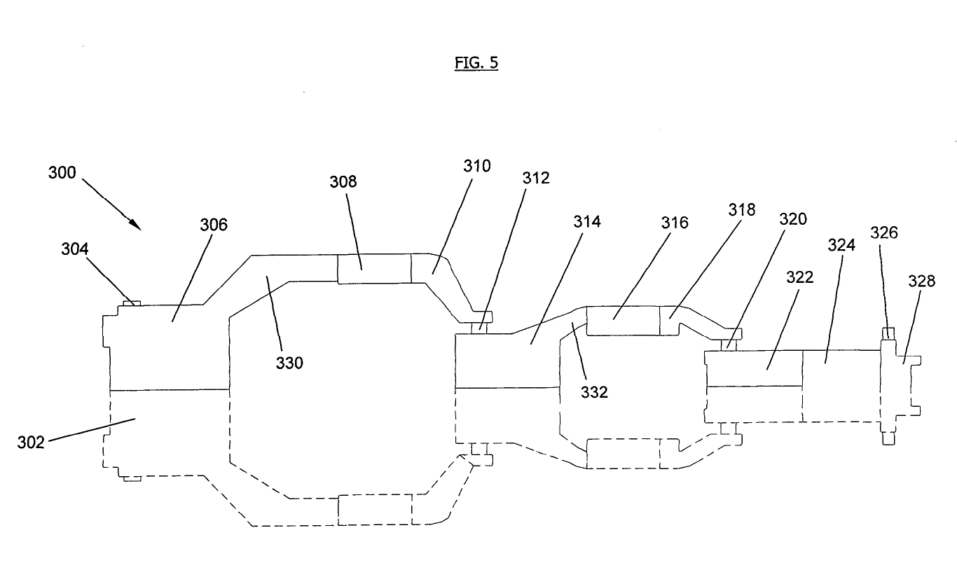

FIG. 5; a plan view of an actuating arm which is able to be used in any embodiment

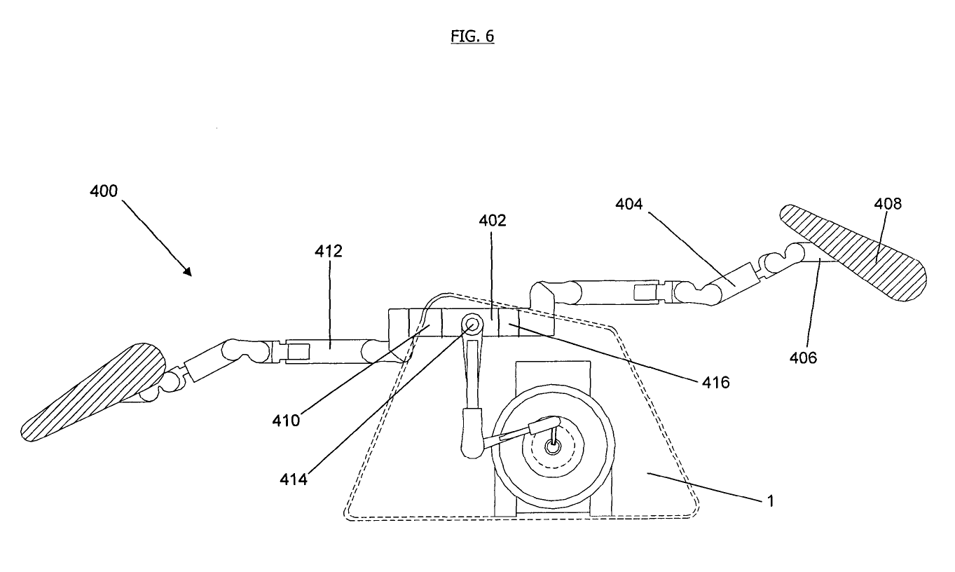

FIG. 6; a side view of a third embodiment of the invention

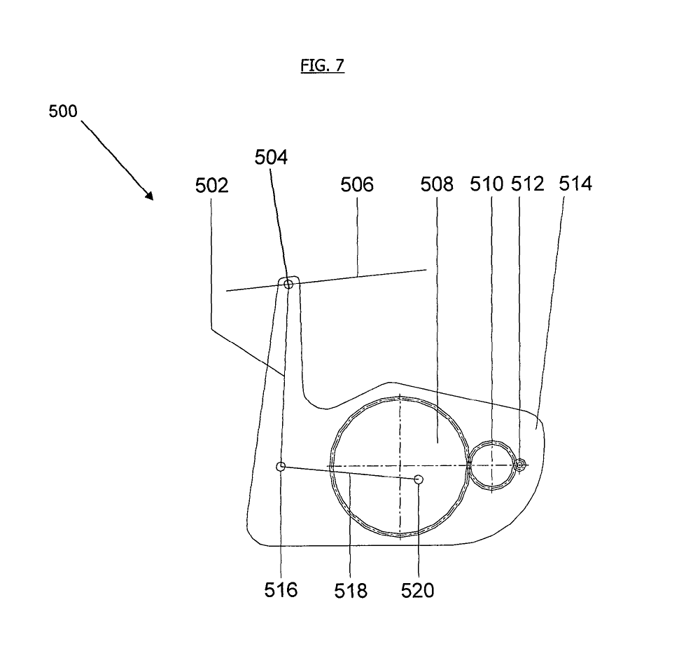

FIG. 7; a plan view of a fourth embodiment of the invention

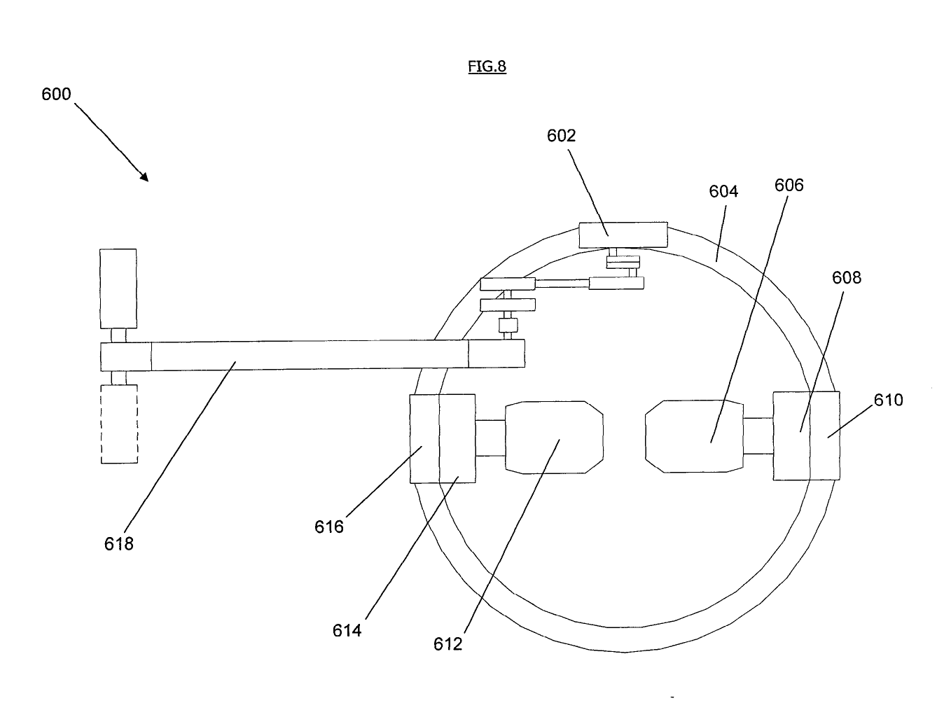

FIG. 8; a side view of fifth embodiment of the invention showing a ring generator arrangement

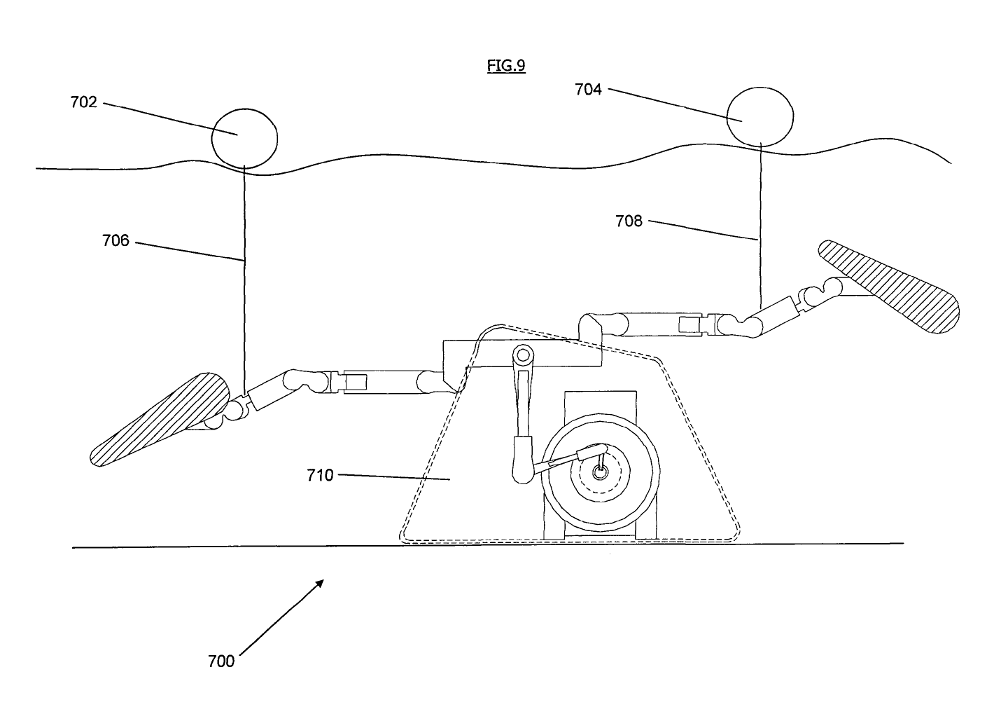

FIG. 9; a side view showing a float arrangement which could be used in tandem with any of the preceding embodiments

The first embodiment typically features at least one wing or hydrofoil 2 which is permanently and or removably attached to the first end of the at least one arm 4. Typically the hydrofoil 2 attaches to the arm 4 via an exit shaft 6 (not shown in FIG. 1 but can be seen from the plan view in FIG. 2) of the at least one rotary actuator 8 which is typically located within the first end of the arm 4. The arm 4 has at least one first end and at least one second end as well as at least one section.

The at least one rotary actuator 8 is at least partially integrated or permanently or removably attached to the first end of the arm 4. It will be appreciated that a rotary actuator can also feature within the hydrofoil 2 and in such a case an exit shaft from the hydrofoil rotary actuator will be integrated with or permanently or removably attached to the exit shaft 6 from the rotary actuator 8 or directly connected to the first end of the arm 4.

The second end of the arm 4 features a rotary actuator 10 which is at least partially or fully integrated with the second end of the arm 4 or permanently or removably attached to the arm. The at least one rotary actuator 10 has at least one exit shaft 12 which is attached permanently or removably to the exit shaft 14 of the rotary actuator 16, the rotary actuator 16 being located at the first end of the first linkage 18. The rotary actuator 16 is at least partially or fully integrated with the first end of the first linkage 18 or permanently or removably attached to the linkage. The first linkage 18 features at least one rotary actuator 16 at its first end and at least one rotary actuator 20 at its second end. The first and second ends are joined together by an element 22 which is able to feature either at least one linear actuator or at least one passive section.

The at least one passive section is at least partially or fully integrated with the first end and second end of the first linkage 18 or permanently or removably attached to the first and second end linkage. Where the element 22 features at least one linear actuator, the linear actuator will be at least partially or fully integrated with the first end and/or the second end of the first linkage 18 or permanently or removably attached to the first and second end linkage whereby it will be appreciated that in this case, the reference to the first and second end it describes the connection to the first and second end rotary actuators 16 and 20.

It will be further appreciated that the at least one linear actuator can be connected to the first and second ends with at least one suitable multi-axis connection and those skilled in the art will understand this at least one multi axis connection could be but is not limited to a rose joint. It will also be appreciated that if the linear actuator extends then the first and second end with the rotary actuators (where present) 16 and 20 of the first linkage 18 will linearly move in a first or second direction and thus linearly change the distance between the respective ends and/or rotary actuators.

It will also be appreciated that where at least two linear actuators are used with the inclusion of at least one multi-axis connection at the first or second end of the linear actuator respective to the first or second end of the first linkage 18 and/or the rotary actuators 16 and 20, not only can the linear distance between the first and second end change, but also the angular distance and respective orientation of the first and second ends and/or the rotary actuators 16 and 20.

The second linkage 24 is able to exhibit all the same functions and features as described for the first linkage 18. This second linkage 24 is able to feature at least one rotary actuator 26 at the first end. The rotary actuator has an exit shaft 28 which is able to be rotably attached or fixed to the exit shaft 30 where the exit shaft 30 is relation to the second end of the first linkage and typically the rotary actuator 20 of the second end of the first linkage 18.

The second linkage has a second end which is able to feature the rotary actuator 32 whereby both 26 and 32 are able to be at least partially or fully integrated with the first end and second end of the second linkage 24 or permanently or removably attached to the first and second end of the linkage respectively.

The second linkage can also feature at least one linear actuator 34, whereby the linear actuator is at least partially or fully integrated with the first end and second end of the second linkage 24 or permanently or removably attached to the first and second end of the linkage.

The at least one linear actuator can move in the first and second direction and as such extend and retract to move the first and second end of the second linkage and where appropriate the at least one rotary actuators, this action linearly separates or linearly draws together the first and second end and where appropriate the rotary actuators. The at least one linear actuator 34 is able to be connected to the first and second end and/or rotary actuators 26 and 32 with at least one suitable multi-axis connection with respect to at least one rotary actuator or end. Those skilled in the art will understand these connections could be such things as but not limited to rose joints.

It will also be appreciated that in this case of multi-axis connections, at least two linear actuators can be used. If at least one linear actuator then extends the first and second end, with or without the rotary actuators 26 and 32 of the second linkage 24 will not only be able to move linearly in the first or second direction with the linear distance between the first and second end changing, but also the angular distance and respective orientation of the first and second ends and or the rotary actuators 26 and 32.

It will be appreciated that where more than one linear actuator is used for both the first and second linkages, each linear actuator is able to extend and retract at different speeds and independently as well as in a synchronised manner respective to each linear actuator in each linkage and respective to the overall movement of each linkage.

The second end of the second linkage 24 is connected to the third linkage 36 via the exit shaft 38 of the rotary actuator 32 and or linkage 24 and the exit shaft 40 of the linkage 36. The third linkage can exhibit all the same functions and features as the first and second linkage and as such a detailed description will not be give due to repetition of the above text.

The rotary actuator at the second end of the linkage 24 is connected permanently or removably and rotatably via the exit shaft 38 to the linkage 36 at its first end via the respective exit shaft 40 thereby connecting the second end of the linkage 24 to the first end of the linkage 36. Typically the linkage 36 is held in a groove within the wheel 42 and is connected to either the wheel 42 and or the shaft 44 at the third linkages second end via the exit shaft 46.

Where the third linkage includes at least one linear actuator, the extension of the at least one linear actuator changes the relative distance between the centre of the wheel 42 and or shaft 44 and as such changes the distance between the first and the second end of the third linkage and distance between the second end of the second linkage and the centre of the wheel and or the shaft 42 and 44 respectively.

As will be appreciated, the wheel 42 is located on a shaft 44 which is retained in position via its relationship to the enclosure 54 and typically but not essentially the enclosure 54 holds the shaft in position with bearings. As will be further appreciated, the linkage 36 is able to be attached or fixed to the shaft 44 directly and in which case the wheel 42 is able to be removed.

The shaft 44 is connected to at least one gearbox 46 which is typically but not limited to a planetary epicyclical type gearbox which allows low rotational entry shaft speed to become a large exit rotational shaft speed. As will be appreciated where several gearboxes 46 are required they may be chained together via their respective output and input shafts. The output from the at least one gearbox 46 is typically but not limited to delivered directly to generator 48. The output shaft from the gearbox 46 may be permanently or removably connected to the input shaft of the generator 48.

All the above components and assemblies are desirably but not essentially retained within housing 54. Typically the housing will feature at least one chamber bounded by walls featuring at least one bearing suitably positioned and retained sufficiently for the operation of the device. The housing may also house at least one spring and or at least one cam gear or at least one cam arm or other such arrangement. Typically where cam gears and cam arms are used, they allow a connection to at least one part within the system, for example the first linkage such that its movement in a section of its movement or all its movement places energy into a spring such that in another section of its movement or for all its movement the energy is given back to the linkage. It will be appreciated such a system can be varied respective to the relationship between the part of the system and cam gear or cam arm. Respective to the cam gear, a spring can be attached to the housing and connected to one or more parts of the mechanism such that energy can be stored and/or released back into the system. It will further be appreciated that the spring and/or cam gear and/or cam arm can be housed, slideably or otherwise in a single or multiple connected chambers.

The device 1 operates in reaction to fluid flow, typically but not essentially, flowing water. The hydrofoil 2 is rotated either by the rotary actuator 8 and/or an internal rotary actuator such that the unit achieves the desired angle of attack with relation to the flow of the fluid. The hydrofoil 2 due to the effect of the moving fluid over at least one surface generates force which moves the hydrofoil in either the first or second direction. As the hydrofoil moves the arm 4 also begins to move in the same direction, the arm's connection to the first linkage via the exit shaft 12 means that the at least one arm pivots about the axis of the rotary actuator 16 exit shaft 14 and consequently the arm 4 moves in the first or second direction with respect to the axis of the exit shafts 14 where the profile of the movement is respective to the relative position of the at least one hydrofoil 2 to the exit shaft axis 14.

Due to the connection between the arm and the exit shaft 12 as the arm moves motion is transferred to the exit shaft 12 and subsequently causes the exit shaft 14 to move in its respective first or second direction. The exit shaft 12 is connected to the linkage 18 via the exit shaft 14 at the first end and as such the linkage 18 begins to move in its respective first and second direction in a generally pendulum type motion resultant from the movement of the arm 4. As the linkage 18 moves in the first or second direction, the second linkage 24 will also begins to move in its respective first of second direction and subsequently this movement of the linkage 24 causes the linkage 36 to rotate about the axis of the shaft 44 and thus subsequently the wheel 42 and/or shaft 44 will rotate in the respective first or second direction. This rotary motion will rotate the gearbox 46 in the respective first or second direction and will subsequently rotate the generator 48 in a corresponding direction.

It will be appreciated that the system operates on a reciprocating motion of the arm 4. As described above, the hydrofoil is positioned to an angle of attack and generates a force. For example, if the hydrofoil is generally towards its lowest point akin to that shown in FIG. 1, as the hydrofoil is rotated to achieve an angle of attack, the force generated will cause the hydrofoil to move generally upwards and in its respective first direction.

As described above, this subsequently causes the arm 4 and linkages 18 and 24 to move in their respective first directions. The arm 4 due to its relationship with the axis of the rotary actuator 16 and therefore the exit shaft 14 will produce an arc like profile at its first end. In a particular example (and without limitation), as the arm 4 approaches generally towards the highest point of the first direction and towards the top of the arc, the hydrofoil can be rotated such that it reverses the angle of attack and starts to move itself and thus the arm and linkages in their respective second directions and thus a reciprocating action is given respective to the arm and the linkages 18 and 24. However, this reciprocating action need not be demonstrated with relation to the wheel 36, shaft 44, gearbox 46 and generator 48. The mechanism as described is such that the reciprocating action is transferred into a generally and continual rotary motion.

It is apparent that the first linkage operates in a motion generally similar to a pendulum motion whilst the second linkage operates in a similar motion albeit in a generally perpendicular orientation and with the addition of the first or second direction movements of the second end of the first linkage. Each of these linkages features at least one linear actuator and for example, if the respective linear actuator extended or retracted the relationship between the first and second end of the respective linkages will be changed such that and typically the respective first and second ends become further apparent or closer together and or the angular and or the orientation changes between them.

In these cases the performance parameters of the system will alter. Furthermore and additionally if the at least one linear actuator in the third linkage 36 was to extend or retract, then the relationship between the second end of the second linkage and the axis of the shaft 44 would change. Therefore at least part of the performance and characteristics of the system are determined by the relative position and therefore the relationship between of the at least one linkage first and second end and the performance and characteristics can be changed by altering that relationship.

It will be appreciated that the at least one linear actuator in the linkages can be operated independently of the other linkage at least one linear actuator or at the same time and at the same speed as the other linkage linear actuators or at different speeds and in the same or different directions. In this sense it will be appreciated that the effective stroke length of each linkage is not fixed, can be changed and can define the systems characteristics. It will also be appreciated that each linear actuator is able to feature the addition of at least one spring and or only at least one spring and or other energy storage and or yielding element and as such they would be able to store and or give back energy into the system.

Each linkage is able to feature at least one rotary actuator as the arm 4 is able to feature at least one rotary actuator. The rotary actuators are able to perform various functions which will add to the usage of the device. For example the at least one rotary actuator 10 in the arm 4, or any other rotary actuator, is able to be powered and as such when power is applied to the rotary actuator, in this example, the arm will move about its axis relation to the exit shaft 12 in either the first or second direction respective to the rotation of the rotary actuator. It will be appreciated that this action is also true with relation (but without limitation) to the rotary actuator 16 and in both cases, it is possible for at least one of the rotary actuators to rotate in the opposite direction and at a synchronous speed to the motion of the arm 4 in either of its first and second directions whereby the motion produced by the arm can be countered by the rotary actuators and as such isolate and keep the mechanism inside the enclose 54 stationary even if the arm 4 is moving.

It will therefore be appreciated that the at least one rotary actuator within the arm and/or linkages are able to produce a gearing effect whereby, for example, the rotary actuators in this case (but not limited to) 10 and 16 can rotate at a partial speed to that being generated by the arm 4 and thus gear the system down as the movement of the first linkage will be a fraction of the movement and or speed of the arm 4. It will be further appreciated that the opposite in terms of gearing up the system is also true and like the synchronous feature described above, this feature can occur at any point in the mechanisms movement cycle and each rotary actuator is able to rotate independently at a different speed and or direction to any other rotary actuator or have synchronisation to at least one other relative rotary actuator.

It will be further appreciated that the gearing effect is further compounded by the usage of the at least one linear actuator in the least one linkage. As described above, if the linear actuators operate and change the characteristics of the system, they are effectively altering and or gearing the system. The at least one linear actuator and the at least one rotary actuator can be operated independent in different respective directions and/or respective speeds or simultaneously at the same respective or different respective speeds and in different respective directions.

These features are particularly advantageous in terms of the rotary actuators as they are able to provide not only a soft start, stop and arm speed or direction change softening and/or the like and/or shock reduction and/or production smoothing to aid the systems generation capacity and electrical grid feed. Typically but not limited to these features with respective to the rotary actuators 10 and 16 are not a feature of the rotary actuator 20, 26 and 32, however the features are able to be installed if the application requires.

Typically but not limited to all rotary actuators are able to feature the ability to store and yield energy from and into the system and to have fixed or variable tension. Typically but without limitation the rotary actuators are able to feature at least one spring such that they can store energy from the system at any set point or variable point in the motion cycle to give back that stored energy at another set point or variable point in the motion cycle.

Each rotary actuator is able to complete its energy storage or yield at a different point to or at the same point as any other rotary actuator. This feature is particularly advantageous due to the cyclic nature of the system and can be used to store energy in the respective first or second directions of the systems components and give that energy back respective to when the arm is generally towards the highest or lowest point of the cycle and particularly but not limited when the arm is on the cusp of, during or post direction change. If a rotary actuator is placed into the hydrofoil or with regards to the rotary actuator 8, a spring installed correctly in the actuator will enable the hydrofoil to move in the event of any sudden changes in flow or a foreign object collision and thus prevent or minimise any potential damage. It will be appreciated that this is also true of the other rotary actuators in that if they feature a spring then and for example, the arm 4 becomes obstructed by a foreign object, then the system is not sudden stopped, the springs allow for a degree of relative movement between the components of the system and thus prevent potential damage.

The ability to focus the energy storage and/or release in certain parts of the cycle in terms of both the rotary and or linear actuators acts to also further smooth the generation of power, system movements and reduces dynamic or otherwise shocks. Furthermore each rotary actuator can feature the ability to dynamically change its energy storage and energy yield and storage capacities synchronised with all other rotary actuators or independently and different for each rotary actuator.

Focusing on FIG. 2, it can be observed that the system may have a first and second side, the first side has been described above in relation to FIG. 1 and the second side 50 can have all the same functions and features as the first side and thus will not be further described. The second side is shown in phantom lines and it indicates that the second side will typically (but without limitation) be the mirror image of the first side. The second side is able to also feature at least one hydrofoil 52, whereby the hydrofoil will be able to introduce the extra force required to rotate the further generator introduced in the second side. It will be appreciated that the at least one rotary and/or at least one linear actuator that are present on both sides of the system can be used to modify the first and second side in terms of any possible imbalance between the sides and as such the first and second side can be harmonised to each other and therefore produce a constant and smooth electrical output which is the generally the same. This feature accounts for any differential movement, wear and/or any other differential in either side with respect to the other including are flexure associated the enclosure or any potential obstructions to one side or the other. One such example is the possibility for the hydrofoil 52 suddenly generates a force greater than that which is generated by hydrofoil 2 and as such any relative motion in advance of the first side by the second side can be corrected by the use of the at least one linear and rotary actuators.

It will also be appreciated to anyone skilled in the art that the first and second side could be two entirely different machines, which have a common connection about the axis of the respective exit shafts 12. In this case the axis shafts 12, instead of exiting the rotary actuator 10 at just one side, would be able to exit the rotary actuator at both sides and as such they would be able to be rotatably joined.

It will be further appreciated the arm 4 is able to become split and mirrored such that each split of the arm can have all the same functions and features as described for the arm 4 and thus be able to operate independently of the other now split arm yet rotate about the same axis and power their respective sides independently of the other.

It will be appreciated that the device is able to be placed into many suitable orientation with regards to flow.

The devices in operation and due to their operation will create a pattern in the fluid post the device. This pattern is able to be utilised to move sediment in the area respective to the device, its operation and the flow. It will be appreciated that this can be conducted as a singular device or where multiple devices are present, each device is able to create a pattern that not only allows for the accumulative carrying of and for example (but without limitation) sediment to be carried through the device network, but also the ability for each device to add to that sediment movement by entering its own post device movement sediment into the body of sediment being moved.

The devices are able to achieve this irrespective of power generation or whilst generating power. This ability to perform functions such as but not limited to sediment sweeping allows for the cleaning of water channels such as river beds, the devices patterns able to work with the flow typically in order that sediment is entered into the flow to be distributed and dispensed into the fluid flow in a highly controlled manner. This machine functionality will reduce the need to, for instance, dredge river beds.

It is also a significant consideration that the effect can be controlled and as such can be more or less active at different times. This functionality that allows the control of the pattern of fluid exiting the device not only to sweep, but also allows effective consideration of the environment where such aspects as fish fry and other aquatic life needs can be safe guarded where possible against disturbance. It will be appreciated that in the case of fish fry certain times of the year are of extreme relevance and thus the devices can be tailored in respective of them.

FIG. 2 also shows an engagement system 56. The engagement system can be used on any device type or embodiment and is essentially an electronically controlled clutch system. To those skilled in the art plenty of such suitable systems are available. The advantage of the clutch system in this application is that it allows a further gearbox and generator to be added into the system or removed from the system respective to requirements. As an example, if the demand for electricity was below the production capacity of the device with both generators operating, one generator and gearbox could be removed from the system and as such reduce the wear on that gearbox and generator whilst matching more closely the consumer demand for power, alternatively the at least one second generator can be brought in and with respect to peak demands as a function or environmental conditions. Of course this feature is able to be on any gearbox and or generator in any embodiment of the device.

FIG. 3 illustrates a rotary actuator 100, in this case but not limited to the rotary actuator is the applicant's own proprietary gearbox described in the Applicant's co-pending International patent application number PCT/GB2010/000250, however any other suitable rotary actuators are able to be used.

In this case the rotary actuator 100 can be used as the rotary actuator for any of the rotary actuator references made in relation to the first embodiment described in FIGS. 1 and 2. Therefore the rotary actuator 100 is especially relevant to the rotary actuators as described by 16, 20, 26, 32, 8 and 10 from FIGS. 1 and 2. The exit shafts described in FIG. 1 and FIG. 2 and namely 6, 12, 14, 30, 38, 28, 40 and 46 are typically the same as that described in this figure as 134. The rotary actuator is a self contained unit with a casing 102 and at least one component and or at least one chamber therein. The at least one component is able to be an exit shaft 134 whereby the exit shaft can be permanently or removably attached to the casing 102 or integrated with the casing 102.

The rotary actuator in this case typically includes at least one actuator 104 which is typically an electric motor attached to the leadscrew 106. The leadscrew is held by at least one bearing and in this case two bearings, 110 and 112. The leadscrew is further able to feature an external drive ability via the shaft extension 108 which is attached or integrated with the leadscrew 106 and held via the bearing 114. The rack nut 116 is meshed with the leadscrew 106 and via the toothed section is meshed with the gear 118. Typically the gear 118 is on the same shaft as the gear 120.

The gear 120 like any other gear is able to feature a spring system which in this case but not limited to uses at least one tine or leaf type spring or mechanical spring or other spring or spring element 122 to connect to an inner ring 124 and an outer ring 126. The gear 120 is meshed with the gear 128 which is in turn meshed with the gear 130. The gear 130 is attached to the exit shaft 134. The gear is attached via node 132 to the spring 136 which is in turn attached to the node 138 whereby 138 is attached to the casing. Typically the motor 104 rotates in the first or second direction, which in turn rotates the leadscrew in the first or second direction. The meshed relationship the nut 116 has with the leadscrew moves the nut along the axis of the leadscrew in the first or second direction resultant from the rotation of the motor and subsequently the leadscrew.

The linear movement of the nut linearly moves the toothed section 140 which rotates the gear 118 to which it is meshed. The rotation of the gear 118 rotates the gear 120 which in turn rotates the gear 128 which in turn rotates the gear 130 and the output shaft 134 in either the first or second direction depending on the rotational direction of the motor as described. The shaft extension 108 is able to be connected to an external rotary actuator such as a manual handle or an electric motor and typically these are able to be used to boost the rotational capability of the drive or if the drive fails such as the motor 104 and the output shaft has a requirement to rotate.

The spring in the elements 126, 122 and 124 combine to form a sprung member. The at least one sprung member has an inner ring 124 is typically (but without limitation) attached to the gear 118 shaft or the casing whilst the outer 126 is typically (but without limitation) attached to the outer gear 120 or the casing. In the first instance with the inner ring 124 connected to the shaft on which both gears are located, the shaft is able to be stationary within the casing with the gears located on the shaft on at least one bearing and the outer ring 126 attached to the gear 120. Therefore as the gear 118 and 120 rotate the elements 122 store energy from rotational motion of the gear 120 and 118 or release energy into the gear 120 as rotational force and therefore motion.

In the second instance, if the gears 118 and 120 are integrated or otherwise rigidly held on the shaft and the shaft rotates, then is typically (but without limitation) the inner ring 124 will is typically (but without limitation) be attached to and held stationary by the casing and therefore and as before the elements will store or release rotational force into the gear 120.

In a third instance, the tines and or leaf type springs are able to be free end leaf or tines typically (but without limitation) attached to the inner ring 124 and is typically (but without limitation) with the inner ring attached to the shaft where is typically (but without limitation) the shaft is able to be stationary as described above. As the gear 120 rotates in one direction energy is placed into the tines or leaf spring whereas as the gear 120 rotates in the opposite direction the energy is released to assist the rotation of the gear in that direction. The spring element 136 operates in a similar manner to the above whereby as the gear 130 rotates the spring 136 stores energy and as the gear 130 rotates in the opposite direction the spring releases the energy as force on the gear 130 to assist rotation. In both cases with regards to both sprung means concerning the components 136 and 126, 122 and 124 they are able to be applied to be applied in any suitable combination on any gear and able to be harmonised to work together as well as for the reduction of backlash and for the optimisation of gear wear. The sprung means is also able to be used with or without an electric motor or other actuator 104 and furthermore they are able to allow the shaft 134 to be held at a pre-set and adjustable tension which yields a resistance to motion and dampening effect such the output shaft is able to be used as a suspension like unit.

Although not shown in its entirety it is possible for the toothed section 140 to be disconnected from the gear 118 and thus allow free wheel of the gear 118. This is typically accomplished via the addition of a bar 144 which runs through the section 140 where section 140 is movably attached to the nut 116. At least one linear actuator is placed at one end of the bar such that activation of the actuator lifts the bar which in turn lifts the section 140, the linear actuator is able to be activated in the opposite direction to lower the bar and as such the toothed section 138 back into a meshed relationship with the gear 118. The bar 144 can also be used to assist the retention of the toothed drive rack 140. The toothed drive rack 140 is located in at least a partially or fully separate or otherwise separated chamber to the section 116 which is meshed with the leadscrew. This separation allows for the toothed rack to be at least partially isolated from the leadscrew 106 as shown in the figure and splits the rotary actuator into two distinct sections as clearly visible from the figure. This is advantageous as energy can be stored in the gear springs as described and in the spring 142 which is located towards one side of the toothed section 140. The specific advantage arrives via this separation of the sides where the springs such as 142, 136 and 122 and like allow the reduction of energy usage by the actuator 104 that is only possible with the separation of the sides in this format.

Therefore and for example, if we take the operation of the renewable energy device as described above we can reference one example although many such examples are present with the device and the rotary actuators usage. Taking the hydrofoil 2, the rotary actuator 8 can include sprung elements, as such when the hydrofoil is moved by the motor 104 via the operation of the rotary actuator 8 the exit shaft rotates and as such starts to rotate the hydrofoil which engages with fluid as the angle of attack becomes sufficient to allow the hydrofoil to generate force and place that force into the system.

During the movement of the exit shaft for the rotary actuator 8 which can as described have all the same functions and features as the gearbox herein described. Therefore and assuming two sprung elements in the gearbox, as the blade is rotated to the desired angle of attack, its rotation will be added to/assisted by the fluid which is moving around it and as such generally little or in some cases no power will not be required to move the hydrofoil and power will typically but not limited to only be used to control the movement of the hydrofoil. As such, with the current gearbox, energy recovered from the fluid assisting the hydrofoils movement can be stored typically in the sprung element 142. It will be appreciated that the sprung element is able to be located at either side of the toothed rack 140.

Therefore when the arm generally approaches the end of one arc cycle and the hydrofoil is to change its angle of attack from the first angle to the second angle. The energy stored in the sprung element 142 is able to be released into the system meaning less energy is required to rotate the exit shaft and as such the hydrofoil. Further still, the spring 142 is typically configured in this example and with relation to the hydrofoil such that when the hydrofoil begins to generate forces resultant from the fluid flow when the hydrofoil is moving from the second angle of attack, a sprung element system similar to that described respective to the tine 122 element can be activated in the gear 128. Therefore and similar to the movement to the first attack angle, as the hydrofoil receives input from the fluid flow it will induce rotational force in the hydrofoil and as such the exit shaft is only required to control the hydrofoils movement and meaning energy can be stored in the at least one energy element respective to the gear 128.

As such, when the arm generally reaches the end of a further cycle and the hydrofoil is to be rotated back to the first angle of attack, the energy stored respective to the gear 128 is able to be released. It will be appreciated that further sprung elements are able to be used including such aspects as CAM profiled sprung gears with CAM profiled receiver with or without and the free end tines which both allow directional and timed respective to position energy storage and release. It will also be appreciated that the stored energy is able to operate with the introduction of power into the system and as such the stored energy is able to be used as a boost in terms of operational speed and thus the reduction in the time it takes to rotate the hydrofoil between the first and second attack angle.

The sprung systems can be used with respect to the components of the rotary actuator 100 and as such any rotary actuator throughout the system within the renewable energy device 1 such as but not limited to 8, 10, 16, 20, 26, 32 and any rotary actuators respective to the third linkage 36. Therefore the movement of the linkages can be allowed and set to either exceed or undershoot the requirements of the system respective to the corresponding movement of the arm 4. This over or undershooting is able to be matched to the change over in the arms reciprocation motion generally at the top and bottom of the arc. As such the linkages are able to keep moving in one direction and or at a different speed to the corresponding arm 4 motions. This ability to use the pre-sets and sprung elements allows the system to feature an extremely smooth generation cycle.

It will be appreciated that the rotary actuators can just include sprung elements and gears with no requirement for an internal actuation means such as the leadscrew 106 and motor 104. Pre-set spring rotary actuators can also include motors 104 to assist in the controlled release of the stored power respective to the arm direction change characteristics and parameters. It will be further appreciated that a plain bar can be used instead of a leadscrew which would allow an unthreaded nut 116 to be slideably engaged. The nut would slide along the axis of the plain bar.

The rotary actuators come in five types, the figures illustrates the two main types of unit with the use of phantom lines for the second main type. The two main types of rotary actuator are the moving basic rotary actuator which is seen in the figure as sectioned, the rotary actuator which is seen with phantom lines and includes at least one further gear, both these types have the ability to feature at least one spring and both these types with just springs and a unit with just a fixed exit shaft.

Further additions although not shown can be made to the rotary actuator with additions such as a CAM profile gear and CAM profile spring charging and release system. A CAM system in this sense works via a profiled gear face and a typically but not limited to inverted profiled face. The profiles of the gear face and the inverted profiled face will interact to yield the charging and release of energy from the profiled assembly into the gear to which it is attached or integrated and thus the system as a whole. Typically the spring charging profiles will interact at least once in the cycle of the gear. This means that the changing of a spring can be completed at a pre-set point in the rotation of the gear when the profiles of the inverted face and CAM gear contract, typically but not limited to the charging profile is rotatably fixed to the casing which in this case is the case 102.

FIG. 4 illustrates a linear actuator 200. Any type of suitable linear actuator is able to be used in any embodiment herein, but a variant of the one illustrated is preferred. The illustrated linear actuator is a compact actuator and detailed in the Applicant's earlier international patent publication no. PCT/GB2010/000261 and thus only a brief description is offered here. The at least one linear actuators 22, 34 and any linear actuator associated with the third linkage 36 or any other linear actuator in the device 1 as shown in FIGS. 1 and 2 can have all the same functions and features as the linear actuator 200 as the linear actuator 200 is able to have all the same functions and features as the linear actuators 22, 33 and any linear actuator associated with the third linkage 36 or any other linear actuator in the device 1 as has been described. The linear actuator 200 is able to feature its own case 202 or be incorporated into a linkage such as linkages 18, 26 and 36 from FIGS. 1 and 2 and or arm 4. The linear actuator features a piston rod 204 which is meshed with a leadscrew 206 which is attached or integrated to the drive column 208. The piston is typically but is not limited to having at least one protrusion 210 which typically but is not limited to engaging with the at least one slot 212 located in the at least one inner column 214. The drive column is located on at least one bearing 216. The linear actuator typically features at least one electric motor 218 although a manual actuator could also be used. The motor is attached to at least one gear 220 such that when the actuator 218 rotates, the gear 220 rotates. The at least one gear 220 is meshed with at least one corresponding gear on the drive column and as such the drive column will rotate as a result of the motor 218 rotating. A plurality of gears can be present between the at least one motor gear 220 and the drive column gear.

The rotation of the drive column in turn rotates the leadscrew 206 and via its meshed arrangement with the piston 204, sees the piston move in the first or second direction depending on the rotational direction of the motor 218. The at least one protrusion 210 of the piston inhibits the pistons rotation and keeps the piston in the correct orientation via its relationship with the at least one slot.

It will be appreciated by someone skilled in the art that many other orientations of the at least one motor 218 with regards to the drive column and or leadscrew are acceptable and the final orientation as well as the number and location of motors will depend on the requirements of the application. For example, it will be appreciated that multiple motors are able to be positioned radially around the drive column and more towards one end than the other or generally central. It will also be appreciated that at least one motor can be positioned generally within the drive column where the drive column gear is typically located on the inside of the column is typically (but without limitation) corresponds to the position of the at least one motor. It will also be appreciated that any combination of the above is able to be used such that and for example, at least one motor is generally positioned on the inside of the drive column whilst another is positioned generally on the outside of the drive column and each can mesh with a respective gear on the drive column via at least one gear suitably located. As described, the orientation, position and number of gears and motors is able to via respective to the desired operation and application.

It will appreciated that the unit is also able to feature at least one spring either in association with electrical or manual mechanical activation or without any such activation and merely a system with the at least one spring which is able to be but not limited to located generally around and/or towards the rear and/or the front of the piston and where the piston can but not limited to feature at least one further set of protrusions which can interact with the spring.

It will be further appreciated that the linear actuator can also feature just a piston 204 that is free to move inwardly and outwardly from the casing, typically but not limited to in this format it would always be used jointly with a linear actuator featuring an electrical actuator in the form of a motor 218 as illustrated, spring activation or manual activation.

FIG. 5 illustrates a plan view of the arm 300. The arm 4 from FIGS. 1 and 2 can have all the same functions and features as the arm 300 as the arm 300 can have all the same functions and features as the arm 4 as have been described. The arm 300 can consist of just one section or the arm can have multiple sections. The figure shows an arm with at least one section and in this case but not limited to three sections.

The first section typically consists of at least one rotary actuator 306 with at least one exit shaft 304. The rotary actuator 306 and the exit shaft 304 can have all the same functions and features as the rotary actuator 10 and exit shaft 12 from FIGS. 1 and 2 respectively. Further and additional to, the rotary actuator 306 can have all the functions and features as the rotary actuator 100 as described in FIG. 3. The rotary actuator is able to feature at least one extended section 330 whereby the extended section can be removably or permanently attached to the rotary actuator casing or more typically the extended section is integrated to the rotary actuator casing. The extended section is in turn removably or permanently attached to the at least one linear actuator 308 and more typically the linear actuator is able to be integrated into the extended section at least in part. The linear actuator 308 is able to feature all the same functions and features as for that described for the linear actuator 200 from FIG. 4 and where the linear actuator 308 is a multiple linear actuator, any combination as described in FIG. 4 (delete . . . 2) can be utilised for each actuator.

It will be appreciated that the linear actuator 308 has a piston unit as described respective to FIG. 4 and that the piston unit can be permanently or removably attached or integrated directly with the frog-leg section 310. Therefore and typically but not limited to as the at least one linear actuator is activated the piston will either extend or retract (move in the first or second direction) and as such the frog-leg section and hence all subsequently attached to the section such as the rotary actuator 314 will either linearly move away from or closer to the rotary actuator 306. It will be appreciated that this linear movement will linearly change the distance between the exit shaft axis 304 and the exit shaft axis 312.

The frog-leg section 310 is able to be permanently or removably attached to the exit shaft 312 of the second section. The exit shaft 312 is typically but not limited to respective to the rotary actuator 314 where the rotary actuator 314 is able to have all the same functions and features as the rotary actuator 100 as described in FIG. 3. As will be appreciated and as is described in FIG. 3, the rotary actuator is able to consist of just an exit shaft as well as include at least one gear and actuation and or spring elements. The rotary actuator 314 as is the sum of the second section is able to have the same functions and features as the first section respective to rotary actuator 306 and for the described rotary actuator 100 in FIG. 3.

Whereby the extended sections 332 can be permanently or removably attached to the rotary actuator 314 and typically although not limited to the extended sections 332 are to be integrated at least one part with the rotary actuator. The extended sections 332 can be removably or permanently attached to the rotary actuator casing or more typically the extended section is integrated to the rotary actuator casing.

The extended section is in turn removably or permanently attached to the at least one linear actuator 316 and more typically the linear actuator is able to be integrated into the extended section at least in part. The linear actuator 316 is able to feature all the same functions and features as for that described for the linear actuator 200 from FIG. 4 and where the linear actuator 316 is a multiple linear actuator, any combination as described in FIG. 4 can be utilised for each actuator. It will be appreciated that the linear actuator 316 has a piston unit as described respective to FIG. 4 and that the piston unit can be permanently or removably attached or integrated directly with the frog-leg section 318. Therefore and typically but not limited to as the at least one linear actuator is activated the piston will either extend or retract (move in the first or second direction) and as such the frog-leg section and hence all subsequently attached to the section such as the rotary actuator 322 will either linearly move away from or closer to the rotary actuator 314. It will be appreciated that this linear movement will linearly change the distance between the exit shaft axis 312 and the exit shaft axis 320.

The third section of the arm 300 respective to the rotary actuator 322 is able to have all the same functions and features as those described for sections one and two and hence they will not be repeated. Clear from the illustration is that the third section as any section is able to feature, is the at least one linear actuator 324 being directly connected to the at least one rotary actuator 322. In both these cases, these actuators can have all the same functions and features as those described for the rotary actuator 100 and the linear actuator 200 respectively.

In this case the linear actuator 324 is able to be at least partially integrated with the rotary actuator 322 or permanently or removably attached. The at least one linear actuator is subsequently able to be permanently or removably attached to the rotary actuator 328 which features the exit shaft 326. The rotary actuator 328 and 322 are able to have all the same functions and features as the rotary actuator 100 from FIG. 3 and the linear actuator is able to have all the same functions and features as the linear actuator 200 from FIG. 4. The piston from the linear actuator 324 is able to be directly integrated at least in part with the rotary actuator 328 or be permanently or removably attached. Typically the rotary actuator 328 has all the same functions and features as the rotary actuator 8 as described in FIG. 1 whereby the exit shaft 326 can have all the same functions and features as the exit shaft 6 from FIG. 2 and both as described with relation to FIGS. 1 and 2.

In this case, the rotary actuator 328 typically connects via the exit shaft 326 to a hydrofoil 2 as seen in FIGS. 1 and 2 and where the rotation of the exit shaft results in the rotation of the hydrofoil and where and as a result of the activation of the linear actuator, the hydrofoil and rotary actuator 324 displaces linearly to either move away or toward the rotary actuator 322. Therefore it will be appreciated that the extension of any linear actuator in the arm 300 where linear actuators are used will linearly displace the end most exit shaft such as 326 or with relation to FIGS. 1 and 2 exist shaft 6 and as such linearly displace the exit shaft away or toward the exit shaft 304 or with relation to FIGS. 1 and 2 exit shaft 12. Therefore and typically the extension and retraction of at least one linear actuator will linearly displace the hydrofoil. Where the hydrofoil and or the exit shaft 326 is linear displaced, the arc profile which the arm travels through and as described in FIGS. 1 and 2 will be able to be altered. The at least one linear actuator in the arm 300 is able to extend and retract at a different speed and or direction or is able to work in a synchronous manner to any other at least one linear actuator in the arm 300 and in both cases irrespective of the section or sections in which they are located. Therefore the arm 300 and its arc profile are able to be altered at any point in its operational cycle such that the relative linear distance between the exit shaft 304 or from FIGS. 1 and 2 exit shaft 6 and the exit shaft 326 or from FIGS. 1 and 2 exit shaft 12 is able to alter. It be appreciated that the at least one rotary actuator in any section can be activated to rotate the associated exit shaft. Therefore if the rotary actuators 306, 314 or 322 rotate the respective exit shafts, then the first, second and third section will rotate respective to at least one axis of rotation. For example, where the rotary actuator 306 rotates, then the first, second and third section will rotate respective to the axis of the rotary actuator 306 and typically the exit shaft 304. As a further example, if the rotary actuator 314 rotates, then the second and third section will rotate respective to the axis of the rotary actuator 314 and typically the exit shaft 312, however, if additionally the rotary actuator 322 rotated its exit shaft 320 then the third section would rotate about the axis of the exit shaft 320 and the third and second section would be rotated about the axis of the exit shaft 312. It will be appreciated to someone skilled in the art that as each rotary actuator rotates its exit shaft, the section in which it is located and the sections as shown to the right of its axis will rotate. It will also be appreciated this allows the exit shaft of the arm 326 or as shown in FIGS. 1 and 2 exit shaft 6 to be rotationally displaced with respect to at least one section and with respect to the exit shaft 304 and as shown exit shaft 12 in FIG. 2.

The hydrofoil is typically attached to in this case the exit shaft 326 and as such the rotation of at least one exit shaft from the at least one section will rotationally displace the hydrofoil with relation to not only the exit shaft of the at least one rotating rotary actuator exit shaft, but also the exit shaft 304 which is also typically the exit shaft 6 from FIG. 2 of the first embodiment. Therefore the arm's arc profile as was described in the first embodiment is able to change as a function of the at least one rotary actuators rotation. Each rotary actuator is able to rotate at the same or different speeds and in the same or different directions independently or simultaneously. Therefore the arm is able changes its arc movement profile at any point in the arc movement cycle. Furthermore each section rotary actuator is able to move at the same speed and direction or different speed or a counter direction and subsequent same or different speed and as such allow many different outcomes to occur. One example of an outcome is for the second sections rotary actuator to rotate at the same speed and in the same direction as the hydrofoil which typically allows the hydrofoil to move along its arc in both directions around the exit shaft 312 axis generally without any movement or force being passed from the hydrofoil to the mechanism.

It will be appreciated that this is a function of all the sections and as such it can be used to soft start the device. As a further example, when the device begins to operate the third section can move with the hydrofoil, then the second section and then the first section whereby as the second and first section start to rotate the third followed by the second section's rotary actuators stop rotating. Once the arm is at the required movement characteristics and or performance, the first sections rotary actuator can begin to stop rotating and thus begin to slowly pass on the arms generated motion and force to the device mechanism. Each rotary actuator from each section can be rotated such that the arm no longer forms a generally linear path in that no one section is in the same orientation as another. It will be appreciated that at least one section is able to not be in the same orientation as at least one other yet the arm is able to pivot about the at least one exit shaft 304. This allows the arm to “hunt” for the best flow of fluid and also to vary its output in relation to the pattern formed in the fluid.

The rotary actuators are able to feature springs as is described in FIG. 3. The at least one spring in this case can be used for multiple applications and effects. As an example, each rotary actuator is able to feature at least one spring where the springs can be as described for usage in FIG. 3. Taking this example, at least one gear can feature at least one sprung element and as such at least one exit shaft is able to be move relative to the sprung element even where the actuation of the rotary actuator is not activated. The effect of this allows the sprung element to absorb and release energy from and back into the system via the arm.

Further to the example, where the arm is typically connected to a hydrofoil and associated with the device as shown in FIGS. 1 and 2, as the angle of attack is reached with the hydrofoil which causes motion forces to be generated, the hydrofoil will move respective to those forces and as such with at least one rotary actuator in the arm featuring a sprung element, any initial force generated will be first absorbed by the sprung element and as such will not generally allow any motion from the arm to transfer to the mechanism of the device until that sprung element has absorbed its energy capacity. Once the sprung elements energy capacity is full, generally the full movement of the arm will be transferred to the mechanism.

As has been described, the arm has a reciprocating motion and as such, once the arm generally reaches the extreme of its arc profile in one direction, the hydrofoil angle of attack is changed to allow the arm to move in generally the opposite direction. It is during this process of changing the angle of attack that the energy stored in the sprung element of the at least one rotary actuator is able to be released back effectively into the motion of the arm where it will be appreciate that the energy will influence and generally increase the acceleration of the arm in that generally opposite direction. This has the effect of smoothing out the motion produced by the arm. It will be appreciated that the sprung elements in any rotary actuator in the arm or the device mechanism are able to be harmonised for a smooth operating device and subsequent smooth power production.

It will be appreciated that linear actuators and the rotary actuators are able to move simultaneously or independently of each other and at the same or different speeds relatively or otherwise. As such the arm is able to displace the exit shaft and therefore the hydrofoil both linearly and rotationally. Further still at least one linear actuator is able to be retained within the arm as illustrated with at least one multi-axis connection, typically to either an extension such as 330 or frog-leg 310 or rotary actuators such as 322. In this manner and typically where more than one linear actuator is situated per illustrated location or otherwise, activation of at least one linear actuator is able to introduce multiple axes of movement in the arm. As an example of the advantage it allows, where at least two linear actuators are located in at least one section, then the activation of one is able to linearly displace where the other linear actuator typically remains deactivated or activated but at a different speed and or direction of displacement.

Taking the illustration it is clearly shown that a second side 302 can be present to the arm, where the second side is able to have all the same functions and features as the first side described above and can be permanently or removably attached or at least partially integrated with the first side or independent of the first side. Typically and for this example, the second side 302 illustrates that at least one section is integrated or attached respective to each rotary actuator.

Therefore and respective to the example, if a linear actuator on the first side extends and a corresponding linear actuator on the second side does not extend respective to the same section or otherwise then the arm will (from a plan view) typically form a curve shaped form. It will be appreciated that other forms can be generated depending on the activation of the linear actuators whereby the resultant is that the exit shaft 326 and therefore the hydrofoil is able to be displaced in many different directions and not simply linearly and rotationally respective to previously described linear and rotary actuation.

For example the hydrofoil is able to produce a figure of eight motion, twist respective to the longitudinal axis of the arm as well as yaw. This allow the hydrofoil and as such the device 1 to adapt to changing flow conditions and yield multiple in-fluid output patterns and allow the device with the rotary actuators independently of each other or not to be tuned respective to dense device field applications, changing environmental conditions or otherwise as is required.

The rotary actuators also allow the arm to effectively fold and reduce its size. Taking the first side alone, this allows the second and third section to rotate and locate next to and at least generally parallel to the first section arm. Where the second side is included, typically the linear actuators allow the first and second section to be displaced linearly whilst the activation of rotary actuators allows each section to rotate and into the previous section and thus produce a folded arm. This folding is advantageous both in terms of logistics as less space is taken by the arm and in terms of operation where the hydrofoils are able to be rotated around to face in an opposite direction to and for example, account for a change in flow direction and or where at least one rotary actuator respective to the arm is able to change the relative angle of attack for the hydrofoil.

It will be further appreciated that the rotary actuator 328 shown as rotary actuator 8 in FIGS. 1 and 2 is able to rotate the hydrofoil through at least 180 degrees to allow not only the angle of attack to be established as described above, but also and as above to allow the hydrofoil to operate if the fluid flow changes direction such as and typically respective to tidal flow where the hydrofoil would face the opposite direction.

It will be appreciated that exit shafts are able to be used irrespective of the other component parts of the rotary actuators and can merely be stub type shafts or other suitable connection points.

FIG. 6 shows the third embodiment 400 which can feature all the same functions and features as the first embodiment 1 as described in FIGS. 1 and 2. The device is typically the same as the first embodiment with the addition of a further arm 404 which is able to have all the same functions as the arm 4 and as the arm 300 as described above. The functions and features that are the same will not therefore be re-described, only those which are additional for this second embodiment. The at least one rotary actuator 410 is referenced as 10 with respect to the first embodiment and is able to have all the same functions and features thereof and the rotary actuators 410, 416 and 406 which like 410 can have all the same functions and features as 10 as well as them all being able to have all the same functions and features as the rotary actuator 100 from FIG. 3.

The figure shows a device 400 with at least two arms, the first arm 412 which is the same as the arm 4 from FIGS. 1 and 2 and can have all the same functions and features as the arm 300 as described above and a second arm 404 which and as described is able to have all the same functions and features as the arm 4 and 300 as described in FIGS. 1, 2 and 5.

Unlike the first embodiment, both arms connect typically but not limited to via at least one pivot holding bracket (hereinafter also referred to as “joe-ware unit”) 402. The joe-ware unit joins to the exit shafts at the first end of the respective arms 412 and 404 and typically the exit shafts of the rotary actuators 410 and 416. The joe-ware unit is able to be permanently or removably attached to the either rotary actuator and or at least partially integrated with each actuator. The unit has an exit shaft 414 which and with reference to FIGS. 1 and 2 typically is removably or permanently attached to the exit shaft 12.

The second arm has at least one rotary actuator and at least one linear actuator and is typically (but without limitation) the at least one rotary actuator 406 is located at the end of the arm whereby and typically its exit shaft is connected to the hydrofoil 408. The rotary actuator 406 when activated will rotate the exit shaft and as such change the orientation of the hydrofoil 408 in terms of angle and of attack as well as its direction of action. This is akin to the hydrofoil as described above where the hydrofoil via the action of the actuator 406 is able to rotate through at least 180 degrees such that it is able to face in an opposite direction typically respective to tidal flow and its two directional flow patterns.

With reference to FIGS. 1 and 2, it is clearly illustrated that with two arms the device 400 has at least two hydrofoils. Each hydrofoil is controlled in terms of its orientation by at least one rotary actuator. The unit 400 and the subsequent mechanism is able to receive force and motion from the at least two arms and therefore the at least two hydrofoils which are connected to the pivot holding bracket (joe-ware unit) 402, thus movement of the arms moves the (joe-ware unit) 402 which, via its exit shaft 414, passes the motion and force to the mechanism such that electricity can be produced.

Typically and for example, where the device is located in a tidal type fluid flow, both hydrofoils as illustrated will face in the same direction with the leading edge of the hydrofoil which is seen in the figure as the wider most area located on the right hand side of each hydrofoil facing into the fluid flow. In this case and for this example, each hydrofoil will have a differing angle of attack respective to the direction of flow, one will generally point upwards, whilst one will generally point downwards as is shown in the figure. The effect this has is that one hydrofoil generates an upward force whilst one generates a downwards force. As above, each of the arms is attached to or integrated with the joe-ware unit 402 which as the arms move, one in an upwardly direction and one in a downwardly direction, pass the combined motion and force created by the hydrofoils to the mechanism via the exit shaft 414 and as such 12 from FIGS. 1 and 2.

The main advantage of this at least two hydrofoil accumulated force and motion unit is that the respective force required to move the mechanism is split between the hydrofoils and as such each hydrofoil is able to be smaller respective to just one hydrofoil and arm being used. Further still the hydrofoils can be but are not limited to being a margin out of synchronisation with each other and as such each can supply force and motion respective to the others change of angle of attack and advantageously smooth the production of electricity and the units operation.

Furthermore and typically but without limitation, due to the multiple section arm capability and the at least one linear and/or rotary actuator therein each hydrofoil is able to be at a different horizontal level. With the multiple combinations of all the above described, the two hydrofoils can be configured to actively balance each other using the linear and rotary actuators.

It will be appreciated that for the first and second embodiment, the arm length is able to be varied, as such and generally for slower flows of fluid the arms are able to be shorter, where as for generally higher flows of fluid the arms are able to be longer. To define further, the distance between the hydrofoil on each arm to the exit shaft 414 axis can change and as such the reciprocation speed as a function of the overall reciprocation cycle can be increased, decreased or kept constant for varying fluid flows. With this at least one moveable geometry arm and the addition of the moved geometry mechanism, the device has a distinct advantage over all prior art.

FIG. 7 illustrates the fourth embodiment of the device 500. The fourth embodiment is able to have all the same functions and features as the first, second and third embodiments and all other features and functions respective to the at least one linear actuator, rotary actuator and arm from FIGS. 3, 4 and 5 respectively.

Typically the fourth embodiment will be generally very similar to the first three embodiments and as such detail will not be described that will repeat that given above. The fourth embodiment typically features an arm 506 that which features an exit shaft 504 held in the casing 514. The exit shaft is suitably connected to a linkage 502 which is further connected to a second linkage 518 via a further exit shaft 516. As commented, the linkages can feature at least one rotary actuator such as that described in FIG. 3 and at least one linear actuator as that described in FIG. 4. The arm 506 is able to be as that described in FIG. 5.

This embodiment uses a plurality of gears unlike the previous embodiments prior to the gearbox and generator. In this case, as the arm reciprocates generally upward and downward, the linkage 502 moves in a pendulum type motion which in turn moves the second linkage in a corresponding manner. The second linkage is rotationally attached to the first gear 508 via the connection 520. Therefore as the motion and force of the arm enters the system resulting in the second linkage moving respective to the first linkage motion and the connection 520 to the gear 508, the gear 508 will rotate. The gear 508 is meshed with at least one gear. In this case the gear 508 is meshed to the gear 510 which is in turn meshed with the gear 512, however the number of gears involved in this drive train is able to vary. The gear 512 is typically but not limited to integrated with a shaft which then transmits the rotational motion and force to and typically a further gearbox and then a generator, however the drive train can feature sufficient gears to allow the gear 512 shaft to directly rotate a generator.

FIG. 8 illustrates a further embodiment of the device, 600, which can have all the same functions and features as has been described above across all embodiments and assemblies such as the rotary actuator 100, the linear actuator 200 and arm 300. The embodiment as above is able to feature at least one rotary actuator, at least one linear actuator and at least one arm. In this case the arm 618 is shown and as referenced, this is akin to and can carry all the same features and functions as the arm 4 in FIGS. 1 and 2 and the arm 300 in FIG. 5.

Due to the nature of the device featuring many of the same functions as the embodiments described above, only additional items will be described. As can be seen in the figure, the device has typically and generally got the same mechanism arrangement as the other embodiments. However, the mechanism does not directly contact a generator via a gearbox. In this case the system employs at least one gearbox or typically at least one bevel or other gear 602 whereby the movement of the arm 618 results in the rotation of the typically but not limited to bevel gear 602. The gear 602 is meshed directly or via at least one other gear to the gear ring 604 whereby rotation of the gear 602 rotates the ring gear 604. The ring gear allows for at least one generator set which typically consists of a gearbox 610, one clutch 608 and one generator 606 to be connected with it and typically this is achieved via a gear mesh arrangement between the gearbox 610 and the gear ring 604.

It will be appreciated that this relationship can include at least one gear that will mesh with either the gear ring and or the gearbox. As such the rotation of the gear via the motion of the arm will provide rotation to the gearbox 610 and the therefore the generator 606 when the clutch is deactivated and power will be produced. However, when the clutch is activated, the generator will be disconnected from the gearbox and thus no power will be produced. It will be appreciated that the gearbox 610 and the clutch 608 can be moved such that when the clutch is activated both the gearbox and the generator are disconnected from the ring gear and as such the clutch will have a meshed relationship with the ring either directly or via at least one meshed gear.

The figure also shows a secondary generator set consisting of a generator 612, clutch 614 and gearbox 616 connected to the ring gear 604. It will be appreciated that this secondary set can have all the same functions and features as the first set described above. It will be further appreciated that the many generator sets can be connected to the ring gear. Therefore if the force generated by the at least one hydrofoil increases then the clutches on the at least one generator set can be deactivated and thus connect a further generator set to the ring gear to increase the generated power from the system.

It will also be appreciated that if the force being generated by the arm reduces, then the clutches can be activated and thus disconnect at least one generator set from the ring gear. It will be furthermore appreciated that the ring gear is referenced in this application, however it will be understood that any form of power and motion transmission can be used to connect the generator sets together, this could for example be a chain or a drive train transmission with typically a plurality of gears and even fluid system such as a transmission including hydraulics can be utilised.

It will be further appreciated that the clutch systems allow for the disconnection and connection of the generator sets in a short time period and as such the generator sets can be connected and disconnected quickly to allow them to respond to even the shortest of force increases giving by the arm.

FIG. 9 illustrates a further embodiment of the device, 700. The device 700 features a unit 710 which can have all the same function and features described for all the embodiments and feature at least one linear actuator, gearbox and arm as per those embodiment and with relation to FIGS. 3, 4 and 5 respectively. As such these will not be described in detail.

However, the device is also able to feature the addition of units 702 and 704 which are typically float units. Typically these units float on the surface and feature at least one unit and where more than one is used connections can be present between them which allow the generation of electricity to take place and power to flow between them.

Typically the units float on the surface of the water and move up and down with respective to the surface and typically resultant from waves. The units 702 and 704 are typically connected to the device 710 via lines 706 and 708 whereby the lines allow electricity in terms of both power and communications to flow between the units 702 and 704 and the device 710. Typically but not limited to these units are connected as illustrated to at least one arm of the device 710. Each unit 702 and 704 typically but not limited to carries a system for “paying in” and “paying out” the lines 706 and 708.

The at least one arm as has been described of the device 710 will move generally upward and downward. The motion of the water will move the units 702 and 704 upward and downward and therefore where the upward or downward stroke of the arm and the upward or downward stroke of the respective unit 702 and or 704 occur at the same time, further force can be produced by the arm and passed into the system. It will be appreciated that where the strokes are in different directions, the “pay in” and “pay out” systems can be used to lengthen or shorten the line at least one 706 and 708 accordingly.

The units 702 and 704 can also feature solar panels and if required and typically with the usage of internal batteries can store electricity. This storage system could be used in locations where for example an electric boat wishes to recharge. The units 702 and 704 are also able to provide power hook up points where electricity produced by the units and or the device 710 can be used to and as commented recharge an electric boat or be used for other purposes such as connecting power cables to supply an electricity application including an electric grid. It is also possible to charge hybrid boats where and typically but not limited to boats have batteries and internal combustion engines.

The units 702 and 704 are also able to be used to lift a device 710 from under the surface to near or to being on the surface. Therefore in this case and example, the units 702 and 704 would have sufficient buoyancy to allow such to occur and would typically but not limited to the lifting or indeed lowering a device to or from the surface or near to the surface and in the case of lowering to the required depth using the “pay in” and “pay out” function. It will be appreciated to someone skilled in the art that the “pay in” and “pay out” capability can be provided in a number of suitable ways.

1. A fluid actuated energy generator, comprising:
an output shaft rotatably mounted in a housing;
a first linkage arranged to rotate with the output shaft and extending in an axis orthogonal to the axis of the output shaft;
a second linkage rotatably mounted in relation to the first linkage at the radially most distal end thereof, the first and second linkages being arranged for rotation in parallel planes;
an actuating arm rotatably mounted in relation to the second linkage at the radially most distal end thereof and arranged for rotation in a parallel plane with the first and second linkages; and
at least one blade rotatably mounted in relation to the arm at the radially most distal end thereof and arranged for rotation in a parallel plane with the arm, and the first and second linkages, the longitudinal axis of the blade extending orthogonally to the longitudinal axis of the arm.

2. A fluid actuated energy generator as claimed in claim 1, further comprising:
a third linkage rotatably mounted in between the first linkage and the second linkage at the radially most distal end of the first linkage and the radially most proximal end of the second linkage.

3. A fluid actuated energy generator as claimed in claim 1, wherein the first linkage is connected (I) directly to the output shaft or (II) to a first of a chain of gears, the last gear in the chain being directly connected to and configured to rotate the output shaft.

4. (canceled)

5. A fluid actuated energy generator as claimed in claim 1, wherein the blade comprises a cambered foil.

6. A fluid actuated energy generator as claimed in claim 1, wherein one or more of the linkages incorporates a linear actuator for adjusting the axial length of the linkage.

7. A fluid actuated energy generator as claimed in claim 1, wherein the first linkage is attached to the output shaft via a wheel fixedly mounted on the output shaft.

8. A fluid actuated energy generator as claimed in claim 1, further comprising:
one or more multi-axis joints at the proximal and/or distal ends of one or more of the linkages, optionally (I) the multi-axis joint forms a rotatable mount or (II) the multi-axis joint is provided in addition to a rotatable mount, optionally the multi-axis joint is a rose joint.

9. (canceled)

10. (canceled)

11. A fluid actuated energy generator as claimed in claim 1, wherein one or more of the rotatable mounts comprises a powered rotary actuator.

12. (canceled)

13. A fluid actuated energy generator as claimed in claim 1, wherein the output shaft is connected as an entry shaft to one or more gearboxes, optionally the one or more gearboxes is a planetary epicyclical type gearbox arranged to transform a low rotational entry shaft speed into a relatively higher rotational exit shaft speed, optionally incorporating multiple gearboxes linked in a chain with the exit shaft of one gearbox forming the entry shaft of an adjacent one in the chain.

14. (canceled)

15. (canceled)

16. A fluid actuated energy generator as claimed in claim 1, wherein the blade is configured to rotate about an axis which extends through its body.

17. A fluid actuated energy generator as claimed in claim 1, wherein the actuating arm includes more than one rotatable joint.

18. A fluid actuated energy generator as claimed in claim 1, further comprising:
one or more resilient, energy storing means arranged in relation to one or more of the linkages to absorb energy when movement of the respective linkage occurs in a first direction and release energy when the respective linkage moves in a second direction, optionally the energy storing means is responsive to linear movement of the linkage, optionally the linkage incorporates a linear actuator and the energy storing means is responsive to length adjustments of the linkage resulting from actions of the linear actuator, optionally the energy storing means comprises one or more of a spring, cam gear or cam arm.

19. (canceled)

20. (canceled)

21. (canceled)

22. A fluid actuated energy generator as claimed in claim 1, wherein one or more of the rotatable mounts comprises a rotary actuator, optionally comprising (I) multiple rotary actuators, each arranged to rotate independently at a different speed and/or direction or (II) multiple rotary actuators, two or more of which are arranged to rotate in synchronicity with each other, optionally the one or more rotary actuators is in the form of a gearbox comprising an actuator, a leadscrew arranged to be rotated about its axis by the actuator, a rack nut threadably engaged with the leadscrew and arranged such that rotation of the leadscrew drives the rack nut longitudinally with respect to the leadscrew, a toothed section integral with or coupled to the rack nut for longitudinal movement with the rack nut, a shaft, a gear integral with or coupled to the shaft and arranged such that rotation of the gear causes rotation of the shaft and the toothed section arranged to mesh with the gear, such that the longitudinal movement of the toothed section causes rotation of the gear, and the toothed section is radially distanced from the leadscrew permitting housing of the leadscrew in a chamber separate from the toothed section, optionally the gearbox includes energy storage means arranged to store energy during at least part of the rotation of the shaft to be released during another part of the rotation of the shaft and in which the energy storage means comprises a spring associated with the gear.

23. (canceled)

24. (canceled)

25. A fluid actuated energy generator as claimed in claim 1, wherein multiple linear actuators are associated with two or more linkages, each being arranged to adjust a length of a linkage independently of one or more others at a different speed and/or in a different direction.

26. A fluid actuated energy generator as claimed in claim 1, wherein multiple linear actuators are associated with two or more linkages, and two or more are arranged to adjust a length of a linkage in synchronicity with each other.

27. A fluid actuated energy generator as claimed in claim 2, comprising a pair of output shafts rotatably mounted in a housing, a pair of first linkages, each arranged for rotation with one output shaft of the pair of output shafts and extending radially therefrom, a pair of third linkages, each rotatably mounted in relation to one linkage of the pair of first linkages at the radially most distal end thereof, a pair of second linkages, each rotatably mounted in relation to one linkage of the pair of third linkages at the radially most distal end thereof, the pairs of first, second and third linkages all being arranged for rotation in parallel planes, a single actuating arm rotatably mounted in relation to both linkages of the pair of second linkages at the radially most distal end thereof and being arranged for rotation in a parallel plane with the pairs of first, second and third linkages, and at least a pair of blades rotatably mounted in relation to the arm at the radially most distal end thereof, on opposite sides thereof, and being arranged for rotation in a parallel plane with the arm and each pair of first, second and third linkages, the longitudinal axis of each of the blades extending orthogonally to the longitudinal axis of the arm, optionally the rotatable mount between the arm and the pair of second linkages is arranged about a single shaft connecting each of the pair of second linkages to each other.

28. (canceled)

29. A fluid actuated energy generator as claimed in claim 1, further comprising:
a second actuating arm rotatably mounted on the same axis as the first actuating arm, optionally the second actuating arm extends in an opposite direction to the first actuating arm.

30. (canceled)

31. A fluid actuated energy generator as claimed in claim 1, further comprising:
a clutch system associated with the output shaft and configured selectively to connect and disconnect the shaft with a generator.

32. (canceled)

33. (canceled)

34. A fluid actuated energy generator as claimed in claim 1, wherein one or more linear actuators comprises a leadscrew rotatably mounted about its longitudinal axis and including a threaded portion, a drive rod including a threaded portion threadably engaged with the threaded portion of the leadscrew, the drive rod having an axis generally coincident with or parallel to the longitudinal axis of the leadscrew and mounted to permit longitudinal movement along its axis and to allow relative rotation between the leadscrew and the drive rod, a sheath provided around the drive rod, and a gear column arranged generally coaxially with the axis of the leadscrew and encircling the leadscrew, the rod and the sheath, the gear column including a gear through which drive can be applied to rotate the gear column and being fixedly attached to the leadscrew such that rotation of the gear column causes rotation of the leadscrew with respect to the drive rod to cause the drive rod to extend and/or retract, optionally the one or more linear actuators include energy storage means arranged to store energy during at least part of the length adjustment cycle, the energy storage means being in the form of a spring arranged around and engaging with a piston.

35. (canceled)

36. A fluid actuated energy generator as claimed in claim 1, wherein the arm comprises multiple sections connected via rotatable mounts, optionally the section comprises an extension extending radially from a rotary actuator, an attachment component for connecting with an adjacent section or the blade and a linear actuator integral with the extension and terminating in the attachment component, optionally the linear actuator comprises a leadscrew rotatably mounted about its longitudinal axis and including a threaded portion, a drive rod including a threaded portion threadably engaged with the threaded portion of the leadscrew, the drive rod having an axis generally coincident with or parallel to the longitudinal axis of the leadscrew and mounted to permit longitudinal movement along its axis and to allow relative rotation between the leadscrew and the drive rod, a sheath provided around the drive rod, and a gear column arranged generally coaxially with the axis of the leadscrew and encircling the leadscrew, the rod and the sheath, the gear column including a gear through which drive can be applied to rotate the gear column and being fixedly attached to the leadscrew such that rotation of the gear column causes rotation of the leadscrew with respect to the drive rod to cause the drive rod to extend and/or retract, optionally the linear actuator includes energy storage means arranged to store energy during at least part of the length adjustment cycle, the energy storage means being in the form of a spring arranged around and engaging with a piston.

37. (canceled)

38. (canceled)

39. (canceled)

40. A fluid actuated energy generator as claimed in claim 1, comprising a pair of arms rotatably mounted on a common axis and arranged in a back to back configuration to operate as a single unit.

41. A fluid actuated energy generator as claimed in claim 1, wherein the arm includes one or more second axis rotary actuators arranged to provide rotation in a plane orthogonal to the rotatable mounts, thereby to enable roll, pitch and yaw movements of the leading edge of the blade.

42. A fluid actuated energy generator as claimed in claim 1, further comprising:
a gear wheel to which the attachment point of the first linkage is connected eccentrically, whereby to scribe a circle for every rotation of the gear wheel, optionally the gear wheel engages, either directly or via a gear chain, with a toothed ring and the toothed ring also engages with one or more additional gear wheels separate from the first gear wheel, the additional gear wheels each being mounted for rotation with a second output shaft, optionally the second output shaft has a clutch system associated therewith and the clutch system is configured selectively to connect and disconnect the shaft with a generator, optionally comprising multiple additional gear wheels.

43. (canceled)

44. (canceled)

45. (canceled)

46. A fluid actuated energy generator as claimed in claim 1, further comprising:
one or more floats tethered to one or more of the one or more actuating arms, optionally the floats include solar panels arranged to charge batteries carried in the floats or another part of the generator, optionally the floats include power points from which power can be drawn by an external device.

47. (canceled)

48. (canceled)

49. A fluid actuated energy generator as claimed in claim 1, arranged for operation beneath a body of water.

50. A fluid actuated energy generator as claimed in claim 1, further comprising:
one or more generators arranged to be driven by an output shaft.

51. A fluid actuated energy generator as claimed in claim 1, further comprising:
a controller for selectively controlling the operation of moving parts.
